(19) United States
(12) Patent Application Publication
(10) Pub. No.: US 2022/0266420 A1
(43) Pub. Date: Aug. 25, 2022

(54) Method Of Operating A Dental Polishing Apparatus And Dental Polishing Apparatus

(71) Applicant: Ivoclar Vivadent AG, Schaan (LI)

(72) Inventor: Sebastian Gassner, Triesenberg (LI)

(21) Appl. No.: 17/679,780

(22) Filed: Feb. 24, 2022

(30) Foreign Application Priority Data
Feb. 25, 2021 (EP) 21159413.0

(51) Int. Cl. B24B 51/00; B24B 29/02

(52) U.S. Cl. CPC B24B 51/00; B24B 29/02

(57) ABSTRACT

A method of operating a dental polishing apparatus is provided, having a polishing unit driven by a dental machine tool. The polishing unit includes a circular polishing core and a circular polishing assembly particularly surrounding the polishing core. The polishing assembly also has a workpiece to be polished and the polishing assembly deforms elastically when in contact with the workpiece. A numerically controlled steering device moves the polishing assembly along a trajectory on and relative to the workpiece. The workpiece is immersed into the polishing assembly with a constant or substantially constant degree of immersion. The controller adjusts the degree of immersion based on process parameters.

### CROSS-REFERENCE TO RELATED APPLICATIONS

This application claims priority to European Patent Application No. 21159413.0 filed on Feb. 25, 2021, the disclosure of which is incorporated herein by reference in its entirety.

### TECHNICAL FIELD

The present invention relates to a method for operating a dental polishing device, a dental polishing device, a dental machine tool, and CAM software for a dental machine tool.

### BACKGROUND

Dental machine tools are used to produce dental restoration parts, which can also be referred to in general terms as workpieces with regard to the production in the machine tool. These workpieces are produced by the machine tool by means of an ablative process. This includes milling in particular, but also rotary grinding. The particular advantage of rotary grinding for polishing is that the tool is permanently in constant motion. Deceleration and acceleration phases are less pronounced.

Production is typically numerically controlled, i.e., by means of a CNC machine. This guides the tool along a predefined path, a movement path, past the workpiece. The relative movement is based on milling data that specify the movement path. Even with a movement path with a fine resolution of, for example, 0.05 mm, a certain roughness remains on the surface of the workpiece. This is true even if a finishing milling operation with a very low feed rate is used as the last step of the actual manufacturing process.

Therefore, polishing is typically done after the actual manufacturing process, i.e., milling or turning. For this purpose, either a separate polishing device is used, or the machine tool is equipped with a polishing tool without further ado. The polishing tool is then moved along a special path of motion relative to the surface of the workpiece. The polishing tool is much softer than a milling tool, for example. The polishing tool should be moved along the surface of the workpiece with a certain amount of pressure so that the polishing effect is created, which consists of reshaping the surface of the workpiece and removing roughness peaks.

The polishing tool is then clamped with its shank in the machine tool and carries the polishing unit, consisting of a polishing core, which is circular and solid, and the polishing assembly, which surrounds and is softer than the polishing core.

The trajectory is such that the workpiece is immersed in the polishing assembly surrounding the polishing core.

Typically, the polishing tool is replaced when it is worn out, i.e., no longer shows sufficient polishing effect.

Dental restoration parts as workpieces may also have sharp edges. An example is the margin of a crown facing the gingiva. At such edges, the polishing assembly wears out very quickly if the edge is particularly sharp.

The wear of the polishing assembly is sometimes very high. Therefore, replacing the polishing assembly and the polishing tool as a precautionary measure after at least the expected service life, has been suggested, even if this means accepting premature replacement and thus higher costs in many cases.

Consequently, increasing the accuracy of the trajectory of the polishing tool in order to improve utilisation has also been suggested, but without the hoped-for substantial improvement.

US 20130302751 is directed to abrading assemblies and is hereby incorporated by reference. U.S. Pat. Nos. 4,860,215 and 11,179,851 is directed to control systems for robotic manipulators and are hereby incorporated by reference.

### SUMMARY

The invention is based on the task of creating a method for operating a dental polishing device according to the claims, as well as a dental polishing device according to the claims, a dental machine tool as well as CAM software for a dental machine tool, according to the claims, which enables better utilisation of the polishing arrangement without incurring additional costs.

The method according to the invention uses a special numerically controlled control device or controller or a specially adjusted numerically controlled control device or controller. This guides the polishing assembly along a special trajectory along the workpiece to be polished. In one embodiment, the trajectory corresponds to a constant or substantially constant degree of immersion of the workpiece in the polishing assembly. According to the invention, however, the trajectory is readjusted based on specific process parameters. The process parameters may be, for example, the feed rate, the material of the workpiece, the surface of the workpiece, the material of the polishing assembly, the shape of the polishing assembly and/or the contact pressure between the polishing assembly and the workpiece.

In the practical realisation, a dependency on time or distance is assumed. This dependency is determined in material-specific tests, depending on the previous finishing strategy.

A polishing device according to the invention includes a polishing unit which is formed by the polishing assembly and the polishing core. The polishing assembly surrounds or at least partially surrounds the—solid—polishing core in a manner known per se.

The polishing unit also includes the workpiece to be polished. The workpiece is unpolished at the beginning of the polishing process but has been milled. Typically, it has been produced by milling—or rotary grinding—in a dental machine tool and is ready for polishing.

Alternatively, the workpiece may be otherwise manufactured and require a polishing operation.

The workpiece is mounted on a workpiece holder, for example, including but not limited to, an adhesive connection, a screw connection, or a clamping device. The holder is clamped in the machine tool used for the polishing process. The polishing process according to the invention is carried out until the workpiece is sufficiently polished.

In another embodiment of the invention, a constant or substantially constant degree of immersion of the workpiece is also used. In addition, however, at least one dimension of the polishing assembly, in particular the diameter or the radial extension, is measured. Alternatively, the dimensions of the workpiece can also be measured. The measurement is carried out via a sensor, for example, including but not limited to, a camera. According to the invention, the special control device now adjusts the trajectory based on the result of the measurement.

Indirect measurement is also possible with, for example, including, but not limited to, a sound measurement that can be carried out. The intensity of the contact is deduced from the measurement result, and thus indirectly from the wear of the polishing assembly.

In this respect, according to the invention, a trajectory with a constant degree of immersion, calculated by the control device and judged to be good for the polishing effect, is initially determined. A deviation is then determined from this standard trajectory.

The deviation can lead to a less deep immersion or to greater immersion. In this respect, the trajectory is readjusted. The adjustment can be made once beforehand, for example based on material parameters of the workpiece and/or the polishing assembly, or, for example, based on the shape of the polishing assembly. For example, the polishing effect of a disc-shaped polishing assembly and a cone-shaped polishing assembly can be optimised.

This embodiment can also take tool wear into account. If the tool is more worn, the degree of immersion is increased in order to achieve the same polishing effect again.

The target measurement of immersion is not increased. The degree of immersion is adjusted so that it corresponds to the original value again. The adjustment is increased. This is based on the definition that the degree of immersion depends on the original tool, i.e., the nominal diameter.

The phrase “degree of immersion” is used here to describe the degree of immersion of the workpiece and of its surface in a trajectory that results on the surface of the polishing assembly with its nominal diameter, i.e., in an unused state, when the trajectory is traversed without the workpiece.

This degree of immersion is comparatively easy to readjust, since both the nominal diameter of the—new—tool, i.e., the polishing assembly, and the surface and thus the contour of the workpiece are known.

The increase in the real degree of immersion when the tool is worn then leads to the decrease in the polishing effect being compensated for by the tool wear.

According to the invention, it is also alternatively provided to carry out the readjustment during the polishing process.

A sensor or camera is provided for this purpose. The sensor detects the diameter or other radial extension of the polishing assembly, or the dimensions of the workpiece, and sends the measurement result to the control device. The control device then dynamically adjusts the trajectory.

This measure also allows the current polishing effect to be kept constant, but also to be adapted to the polishing situation. When polishing a preparation margin, e.g., a gingival margin of a crown, the control device can reduce the degree of immersion. This ensures both that tool wear is significantly reduced and that the crown margin is not excessively abraded. Furthermore, it ensures that the preparation margin, e.g., the crown margin, is not overheated during polishing. The same measure is possible and useful according to the invention if an inner corner of the workpiece is to be polished with a pointed polishing tool.

The invention is not limited to the new production of such a dental polishing device. Rather, according to the invention, it is also possible to use a dental machine tool, such as a milling machine, and to retrofit this dental machine tool with a dental polishing device. For this purpose, the CAM software of the machine tool is changed or newly installed and the machine tool is equipped with a polishing tool.

The software update then implements the control device according to the invention, with which a degree of immersion can be adjusted based on process parameters or based on the measurement result of a sensor. The CAM software to be updated can also include the firmware of the machine tool.

Alternatively, according to the invention, it is also possible to implement a polishing driver via which the movement data of the machine tool are influenced in such a way that instead of the trajectory corresponding to the movement data, a trajectory offset by the degree of immersion according to the invention is traversed.

In a further embodiment of the invention, CAM software is provided for a dental machine tool which retrofits the dental machine tool to a dental polishing device. The CAM software implements a control device, or retrofits it by means of an update, with which a degree of immersion is readjusted based on process parameters or based on the measurement result of a sensor.

A ceramic for dental purposes can be extremely hard. An example of this is a crown made of lithium disilicate. The associated polishing tool, for example, rotates at 10000 revolutions per minute and exerts a contact force of 4 N. This leads to significant wear.

If the desired contact force is to be 4 N, for example, and the averaged spring constant can be 10 N/mm, a value of 0.4 mm is initially set as the starting degree of immersion by the control device. Depending on the wear properties, the parameters for the adjustment of the degree of immersion are determined empirically.

At a speed of approx. 9000 rpm an adjustment of the degree of immersion of 4 μm/s or 0.2 μm/mm is realistic. With a polishing time of 3 minutes, a relatively constant path speed of 20 mm/s leads to a processing path with a length of 3600 mm. The maximum adjustment of the degree of immersion is therefore 720 μm in both cases, regardless of whether a parameterisation of 4 μm/s or 0.2 μm/mm is selected. These values are only to be understood as examples to explain the correlations. According to the invention, the range of the readjustment can vary greatly, e.g., by between 0.5 μm/s and 20 μm/s or between 50 nm/mm and 1.5 μm/mm. The starting degree of immersion can also be in the range between 50 μmm and 1.5 mm.

Furthermore, for teeth, it is important that material removal from the restoration is kept to the absolute minimum and that no contour changes are made to the restoration.

In a conventional grinding process, the tool is immersed in the ingot until it comes into contact with the final geometry of the workpiece, from which the workpiece and then the finished restorative part are produced. Except for a small amount of wear on the tool, the material removal occurs mainly on the blank. In the process according to the invention, which includes polishing based on NC data, the workpiece already has its final geometry. The process according to the invention only increases the surface quality. If the tool is guided over the surface as in conventional machining processes, there is not an adequate contact force between the tool and the workpiece. In the invention, the required contact forces for the polishing process are achieved by immersing the workpiece by a certain degree of immersion into the rotating tool, which has the polishing assembly. The degree of immersion is determined by the theoretical depth of immersion into the silhouette of the unloaded rotating tool (FIG. 2).

Since the material is mainly removed from the tool and not from the workpiece, the distance between a tool reference point and the workpiece geometry is always reduced according to the invention in order to keep the degree of immersion within a constant range. This ensures the degree of immersion and thus a sufficiently high contact force even for tools with high wear.

The most important variables for the degree of immersion are the contact pressure and the rigidity of the rotating tool. These in turn depend on many other factors of the tool and the workpiece. Grit size, binder, wear, material, surface quality, strength, feed, rotational speed, or coolant, to name but a few.

According to the invention, a stable polishing process is preferably achieved with a degree of immersion greater than 0.05 mm. The degree of immersion is limited upwards by the rigidity of the tool. Values up to 1 mm are favourable according to the invention. However, especially with soft and large tools, this value can also be significantly exceeded.

A degree of immersion is possible both in radial and axial direction to the rotation axis of the tool. A combination of the two directions is also possible. However, if a radial degree of immersion is used, tools with a diameter of more than 3 mm are preferred.

Another important property for process stability and controllability is the change over time of the distance between the tool reference point and the workpiece geometry. It is preferred that this distance does not change more than the initial degree of immersion over a period of 10 seconds. In the case of large dental restorations, a predetermined degree of immersion can lead to intensive material removal at the start of polishing, but almost no polishing at the end of polishing due to tool wear. In a particularly advantageous embodiment, dynamic readjustment during the polishing process is allowed.

In an advantageous embodiment of the invention, the spring constant of the polishing assembly is taken into account. According to the invention, the spring constant can be linked to the degree of immersion. For the nominal tool diameter, the degree of immersion determined according to the invention is the quotient of contact force and spring constant.

If, for example, the desired contact pressure is to be 4 N and, for example, the averaged spring constant can be 10 N/mm, a value of 0.4 mm is initially set as the starting degree of immersion by the control device. This value is increased dynamically as the tool wears.

In an advantageous embodiment of the invention, it is possible to omit the advance calculation of the trajectory and to adaptively calculate and define a trajectory. The sensor or the camera adaptively regulates the degree of immersion via the control device, so that the relative movement between the workpiece and the tool is continuously readjusted with regard to the distance or the force between them.

With this solution, the control device is integrated in the CNC machine or in the CAM software.

The control device determines the degree of immersion. For the sake of good polishing effects, it is favourable if the contact pressure is within an optimum working range. For common dimensions and diameters of polishing assemblies in the dental field between e.g., 8 mm and 12 mm, an optimal working range for the contact pressure would be around 4 N, i.e., for example between 3 and 6 N. For tools with smaller diameters, the nominal contact pressure is reduced. Basically, the smaller the tool diameter, the lower the contact force. For 3 mm tools, perhaps 2 N. For 10 mm tools rather 4 N. 8 mm to 12 mm are preferred, but the function is guaranteed from 3 to over 15 mm.

Due to the dependence of these parameters on the above quotient, it can be seen that a low spring constant is favourable.

However, if the polishing assembly is subjected to excessive pressure, i.e., pressed in such a way that the polishing core becomes effective, there is a steep increase in the spring constant. According to the invention, this operating point should be avoided as far as possible.

According to the invention, a polishing assembly with an average spring constant of, for example, 10 Newtons per millimetre is therefore favourable. According to the invention, it is particularly advantageous if the control device stores a virtual trajectory in advance, e.g., in a memory. This corresponds to the contour of the workpiece but reduced by the degree of immersion. Here, reduced means closer to the workpiece than the actual diameter of the polishing assembly. If a milling tool were used instead of the polishing tool with the same data, considerably more material would be removed.

The virtual trajectory enables simple programming and specifications via milling data, for example in STL format.

In further advantageous embodiments, the preparation border and other sharp edges are excluded from polishing. This can also be realised in advance in the virtual trajectory by setting a negative degree of immersion at these points or by extending the workpiece geometry at the excluded point by a virtual guard geometry. In this way, significant wear of the tool at these points can be completely avoided.

It is also possible to carry out test series in advance for typical dental restorations with regard to the favourable degree of immersion. Now, for example, test polishing procedures are carried out for crowns in three different sizes, with different values for the degree of immersion. In addition, such test polishing procedures can be carried out to assess the required adjustment speed for wear compensation in order to determine how quickly the degree of immersion changes over time.

The degree of immersion can thus be optimised, and a target degree of immersion can be determined for a crown of the same type, which, however, can be changed by adjusting it according to the invention.

In an advantageous embodiment of the invention, the polishing force can also be measured. This applies both to the test series and in practice. For example, this can be done by determining the current consumption of the machine tool. This increases with increasing polishing force and decreases with decreasing polishing force, so that the polishing force can be determined via the current consumption of the machine tool. Alternatively, the polishing force can also be derived or determined via a force sensor or via the speed reduction of the machine tool.

With conventional polishing devices, a milling path is simply followed by the milling machine equipped with the polishing tool. However, this usually leads to an unsatisfactory polishing result. In an advantageous embodiment of the invention, the polishing assembly is placed on a surface of the workpiece and the trajectory runs in the direction of an edge of the workpiece.

In this context, it is particularly advantageous if the trajectory runs transversely to the direction of rotation of the polishing assembly, for example parallel to the axis of the polishing tool carrying the polishing assembly.

The polishing unit consisting of polishing assembly and polishing core can be designed in any suitable way. The polishing assembly may, for example, have bristles or flaps. These extend radially outwards or at least partially radially outwards from the polishing core. An oblique extension can also be used to form a conical polishing unit.

The bristles or flaps may also be angled to form a cup-shaped polishing unit. Preferably, the axial tip of the polishing unit, where the angular velocity is zero, is out of engagement with the workpiece so that no wear occurs there. In the case of an axial tip of the polishing unit, the angle of the axis to the surface should therefore deviate significantly from 90 degrees, e.g., be less than 80 degrees.

A polishing tool according to the invention consists of the polishing unit and the shaft. The shaft is clamped in a spindle of the machine tool or can be clamped there. The shaft can also be made of spring steel, which influences, e.g., increases, the spring constant of the polishing tool. This can be favourable in some applications.

Alternatively, a flexible tool can also be realised as follows:

The tool is in three parts, with the core=steel shaft, an inner ring=soft sponge, and an outer ring=polishing medium.

In an advantageous embodiment, it is provided that several passes with staggered trajectories are realised. The path spacing can be selected to be larger, and several passes can be made with half the path spacing offset. An example of this:
1. polish all surfaces with a path distance of 0.3 mm
2. polish all surfaces repeatedly with 0.3 mm spacing but offset by 0.1 mm from the first passes and in a different order.
3. repeat with 0.1 mm offset.

This execution reduces the punctual effects of tool changes.

In a further advantageous embodiment, the trajectories do not only consist of lines at a defined height or in spiral form around the contour, but in circular or “up/down/forward/backward” movements, similar to those provided in trochoidal milling.

In a further advantageous embodiment, a special sequence of the surfaces to be polished is provided: either polish the deep fissures with a new, filigree tool, or first polish the surfaces and then sacrifice the old tool by pressing it into the fissures.

The alternative is to consider the following: the tool becomes more finely grained with wear and the surface quality increases with renewed polishing, due to the changing properties of the tool. Movement direction of the tool with properties other than the trailing part of the tool, can mean that the polishing process can be accelerated.

In a further advantageous embodiment, it is provided that predefined tool paths are determined independently of geometry data of the restoration, in particular depending on the block size or geometry.

The control device has a degree of immersion control unit with which the degree of immersion can be adjusted. The readjustment is carried out either based on process parameters, or based on the measurement result of a sensor, in particular a sensor as described hereinafter.

According to the invention, it is particularly advantageous that an existing dental machine tool, e.g., a milling machine, can be used for the process according to the invention. By equipping it with a commercially available polishing tool and with adapted software, which forms the control device according to the invention, it can be used as a dental polishing device according to the invention.

In an advantageous embodiment, it is provided that the polishing assembly is part of a polishing tool that can be connected to the drive in a rotationally fixed manner, in particular with its shaft clamped into the tool spindle of the drive, and that the polishing assembly is connected to the shaft of the polishing tool in a rotationally fixed manner.

In a further advantageous embodiment, it is provided that the control device readjusts the trajectory if a polishing force, in particular measured via the respective current consumption of the rotary drive of the machine tool, falls below a predetermined value.

In a further advantageous embodiment, it is provided that the control device controls the trajectory in such a way that the polishing assembly rests on a surface of the workpiece and the trajectory respectively has a direction from the surface of the workpiece, in particular from the centre of the surface to the adjacent edge of the workpiece.

It is preferable that the method for operating a dental polishing device includes a polishing unit which is driven by a dental machine tool, where the polishing unit includes a circular polishing core and a circular polishing assembly, which circular polishing assembly surrounds the polishing core, the polishing device also including a workpiece to be polished, and the polishing assembly being elastically deformed when applied against the workpiece, the method having the following steps: a numerically controlled controller moves the polishing assembly along a trajectory on the workpiece relative to the workpiece in which the workpiece is immersed into the polishing assembly with a constant or substantially constant degree of immersion and the controller adjusts the degree of immersion based on process parameters.

It is preferable that the process parameters include wear behaviour of the polishing assembly determined empirically or in an individual series of tests, and that the process parameters are dependent on the advance, the material of the workpiece, the shape of the workpiece, the material of the polishing assembly, the shape of the polishing assembly and/or the contact pressure between the polishing assembly and the workpiece.

It is preferable that the method for operating a dental polishing device includes a polishing unit which is driven by a dental machine tool, where the polishing unit includes a circular polishing core and a circular polishing arrangement which circular polishing arrangement surrounds the polishing core, the polishing device also includes a workpiece to be polished, and the polishing arrangement being elastically deformed when it is applied against the workpiece, the method including the following steps: a numerically controlled controller moves the polishing assembly along a trajectory on the workpiece relative to the workpiece, in which trajectory the workpiece is immersed into the polishing assembly with a constant or substantially constant degree of immersion, and wherein at least one dimension, in particular, the diameter or the radial extent, of the polishing assembly and/or the dimensions of the workpiece is measured continuously or repeatedly by a camera sensor, an optical sensor, a mechanical sensor or an acoustic sensor, if appropriate, also indirectly, and wherein the controller adjusts the degree of immersion based on a measurement result.

It is preferable that the measurement is carried out as a real-time measurement, and that the controller carries out a regulation of the trajectory, via a polishing force determined by the sensor or derived from an output signal of the sensor, and/or that the regulation carries out the rotational speed of the dental machine tool and/or adjusts the polishing force.

It is preferable that at least one dimension of the workpiece is measured via a sensor prior to execution of the trajectory, and that the controller determines the trajectory of the polishing unit prior to the execution.

It is preferable that a predetermined degree of immersion is greater than 0.05 mm and less than 0.5 mm for immersion devices with a diameter of up to 3 mm, and greater than 0.2 mm and less than 2 mm for tools with a diameter of more than 3 mm.

It is preferable that the numerically controlled controller has a memory in which a virtual trajectory is stored which corresponds to a contour of the workpiece, but reduced by a predetermined degree of immersion, that is, closer to the workpiece than corresponds to the actual diameter of the polishing assembly, if necessary taking into account a tool reference point.

It is preferable that, with a dental restoration part as the workpiece, the controller excludes preparation boundaries of the dental restoration part from the polishing, i.e., a negative degree of immersion is specified at the preparation boundaries, or a virtual protective geometry is inserted over excluded surfaces.

It is preferable that a targeted degree of immersion is determined in advance, based on at least one series of measurements which represents a function of the degree of immersion via a polishing force, measured via a respective current consumption or rotational speed of the rotary drive of the machine tool.

It is preferable that the controller determines wear of the polishing assembly from a drop in the polishing force at a predetermined degree of immersion and emits a signal when the polishing force at the predetermined degree of immersion falls below a threshold value at the predetermined degree of immersion, and that the signal readjusts the compensation movement and/or indicates a tool change.

It is preferable that the controller controls the relative movement between the workpiece and the polishing assembly along the trajectory such that a speed of movement, during contact, is greater than a minimum value of 5 mm/sec or 10 mm/sec, and less than a maximum value of 30 mm/sec or 20 mm/sec.

It is preferable that the polishing assembly is brought into contact with the workpiece exclusively in regions outside the axis and/or a tip of the polishing assembly.

It is preferable that the polishing assembly has bristles or flaps extending in a circular, plate-shaped, cup-shaped, or cone-shaped manner around the polishing core.

It is preferable that the polishing assembly has a diameter which increases with a rotational speed, and the degree of immersion is determined in relation to the increased diameter, i.e., the rotational speed is adapted to the desired degree of immersion.

It is preferable that a dental polishing device is provided with a polishing unit which is in driving connection with a dental machine tool, where the polishing unit has a circular polishing core and a circular polishing assembly surrounding the polishing core, the polishing device further includes a workpiece to be polished, and wherein the polishing assembly is elastically deformed when in contact with the workpiece, wherein a numerically controlled controller is provided, which controls the movement of the polishing assembly along a trajectory on the workpiece relative to the workpiece, and wherein the controller has a degree of immersion control unit, by which the degree of immersion can be adjusted.

It is preferable that a constant or substantially constant degree of immersion with which the workpiece is immersed in the polishing assembly can be set with the degree of immersion control unit, and wherein the immersion degree can be readjusted with the immersion degree control unit based on process parameters or based on a sensor or a camera for recording at least one dimension of the polishing assembly and/or dimensions of the workpiece, and/or wherein the immersion degree can be readjusted with the immersion degree control unit, based on a measurement result.

It is preferable that a dental machine tool is provided having a retrofitted dental polishing device which includes a controller implemented by CAM software or retrofitted by an update of the CAM software, with which a degree of immersion can be readjusted based on process parameters or based on a measurement result of a sensor.

It is preferable that a computer program product for a dental machine tool is provided having a program code with is stored on a non-transitory machine-readable medium, the machine readable medium having computer instructions executable by a processor, which computer instructions cause a controller of a dental polishing device integral or retrofitted on the dental machine tool to perform the method described herein.

### BRIEF DESCRIPTION OF THE DRAWINGS

Further details, advantages and features of the invention will be apparent from the following description of several embodiments of the invention with reference to the drawing, wherein:

FIG. 1 shows an exemplary view of a polishing tool for carrying out a process according to the invention in one embodiment;

FIG. 2 shows a schematic view of an embodiment of a dental polishing device according to the invention for carrying out a method according to the invention for operating a dental polishing device;

FIG. 3 shows a diagram showing the contact pressure plotted against the allowance as the difference between the tool diameter and the CNC diameter; and

FIG. 4 shows a representation of a model for calculating the virtual trajectory for realising the process according to the invention;

FIG. 5 shows a schematic representation of an embodiment with a bounding box on dental indications;

FIG. 6 shows a schematic representation of the pressing force plotted against the machining time or the machining distance;

FIG. 7 shows a schematic representation of an adaptive control of the trajectory, in an embodiment according to claim 3; and

FIG. 8 shows a schematic representation of a trajectory, in an embodiment according to claim 1.

### DETAILED DESCRIPTION

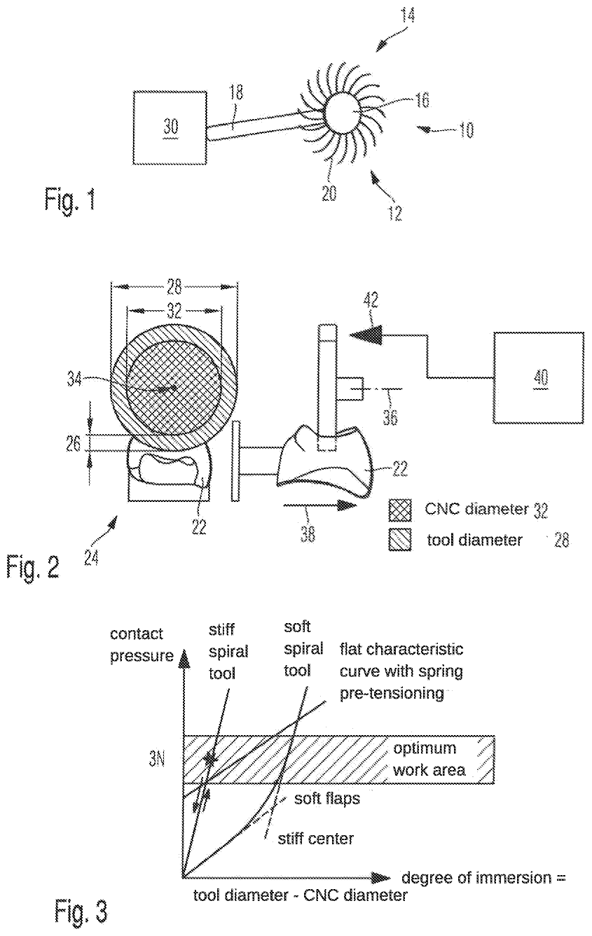

A dental polishing tool 10 is shown schematically in FIG. 1. This comprises a polishing unit 12. The polishing unit 12 includes a polishing assembly 14 and a polishing core 16. The polishing unit 12 is mounted on a shaft 18 and together with the shaft 18 forms the polishing tool 10.

The shank 18 is intended to be guided and held clamped by the tool spindle of a machine tool.

In the embodiment shown, the polishing assembly 14 comprises, inter alia, a plurality of flaps extending in a circular manner. The flaps 20 are each anchored in the polishing core 16 and extend radially from the latter in a manner known per se at a slight angle. They are equipped with granular abrasives and serve the polishing effect.

For polishing, they are guided along a dental restoration part 22, which is also a workpiece 22.

In this case, a polishing force is exerted which causes the flaps 20 to be pressed in the direction of the polishing core 16, or to be partially pushed away laterally, i.e., the polishing assembly 14 is pressed in.

This basic principle is known in itself, and the description here serves to clarify the terms used.

In the exemplary embodiment, the diameter of the polishing assembly 14 is 9 mm and that of the polishing core is 4 mm.

The workpiece 22 is shown in FIG. 2. FIG. 2 also shows the polishing device 24, in front view on the left and a side view on the right. The polishing device 24 consists of the workpiece 22 and the polishing assembly 14.

According to the invention, the polishing unit 12 is guided over the workpiece 22 in such a way that a constant or substantially constant degree of immersion 26 is provided.

For this purpose, a known tool diameter 28 is assumed. This corresponds to the diameter of the tool in the unused state. The polishing tool 10 is clamped in a CNC machine tool 30 and the tool is guided over the surface of the workpiece 22 in such a way that the degree of immersion 26 is produced. For the CNC data, it is assumed that the tool 10 has a diameter that differs from the tool diameter 28 by the degree of immersion 26. This diameter is referred to as the CNC diameter 32.

The control is carried out based on a tool reference point 34. In the example, this is located on the axis 36 of the polishing tool 10.

A schematically shown control device 40 is provided, which is part of the CNC machine tool 30. The control device 40 controls the spatial movement of the tool reference point 34 and also the spatial movement of the workpiece 22. The relative movement between tool 10 and workpiece 22 and thus the trajectory 38, and so at the same time the relative movement between tool 10 and workpiece 22, results from the difference in movement. In the view shown on the right in FIG. 2, the movements in the drawing are from right to left, i.e., essentially parallel to axis 36.

The material removal and in particular the material reshaping occurs transversely to this trajectory 38, in the drawings in FIG. 2 to the right into or out of the drawing plane.

During the polishing process according to the invention, wear of the tool 10 occurs. This wear also results in the actual current tool diameter being smaller than the tool diameter 28.

To compensate for this, the trajectory 38 is readjusted in the direction of greater convergence between the tool reference point 34 and the workpiece 22.

This change in trajectory 38 is controlled by the control device 40. The control occurs based on any suitably selected parameters, for example the feed, the material of the workpiece, the shape of the workpiece, the material of the polishing assembly, the shape of the polishing assembly 14 and/or the contact pressure between the polishing assembly 14 and the workpiece 22.

In a further embodiment, a sensor 42 is used which is connected to the control device 40 and readjusts the trajectory 22. The sensor is used to measure the polishing assembly 14 and/or the dimensions of the workpiece 22, preferably continuously.

The sensor 42 is preferably an optical sensor or camera. However, it is also possible to use a mechanical sensor instead, as well as a tactile sensor or an acoustic sensor, or to evaluate the signals from the control device instead of the sensor.

As can be seen from FIG. 2 in comparison with FIG. 1, the radial extension of the polishing assembly 14, i.e., the radial length of the flaps 20, is significantly greater than the degree of immersion 26, corresponding to the difference between the tool diameter 28 and the CNC diameter 32.

This reliably prevents the application of excessive pressure to the polishing assembly 14. The disadvantage of applying excessive pressure would be extremely high wear and, in addition, a drastic drop in elasticity.

In contrast, the spring constant essentially stays the same in the desired range of the degree of immersion 26. The polishing assembly 14 is elastic and deforms with a substantially constant spring constant when it strikes the surface of the workpiece 22.

As already mentioned, the spring constant is the quotient of the contact pressure and the degree of immersion 26. Conversely, the degree of immersion 26 can be calculated from the quotient of contact pressure by spring constant.

For example, a contact pressure of 4 N and a spring constant of 5 N/mm result in a degree of immersion of 0.8 mm.

A low spring constant allows a large working range. Please refer to the graph in FIG. 3 below. The contact pressure is plotted against the degree of immersion 26.

In the example shown, the optimum contact pressure is 3 N, and the optimum working range is between 2.5 N and 3.5 N. The contact pressure, i.e., the contact pressure per unit area, is decisive for the polishing effect.

It is advantageous to achieve an essentially constant contact pressure through the flexibility of the polishing assembly 14, with a relative independence from the degree of immersion.

In this embodiment example, the contact pressure is higher than in the embodiment example cited above. Accordingly, the optimum working range is shifted towards a greater degree of immersion, corresponding to an overpressure of the polishing assembly 14.

In this case, the higher spring constant of the stiff centre, i.e., of the polishing core 16, is effective, with the corresponding disadvantages.

One solution is to implement a spring preload of the shaft 18, for example by manufacturing it from spring steel or in the three-part design described above.

The spring pre-tensioning then results in a flat characteristic curve again.

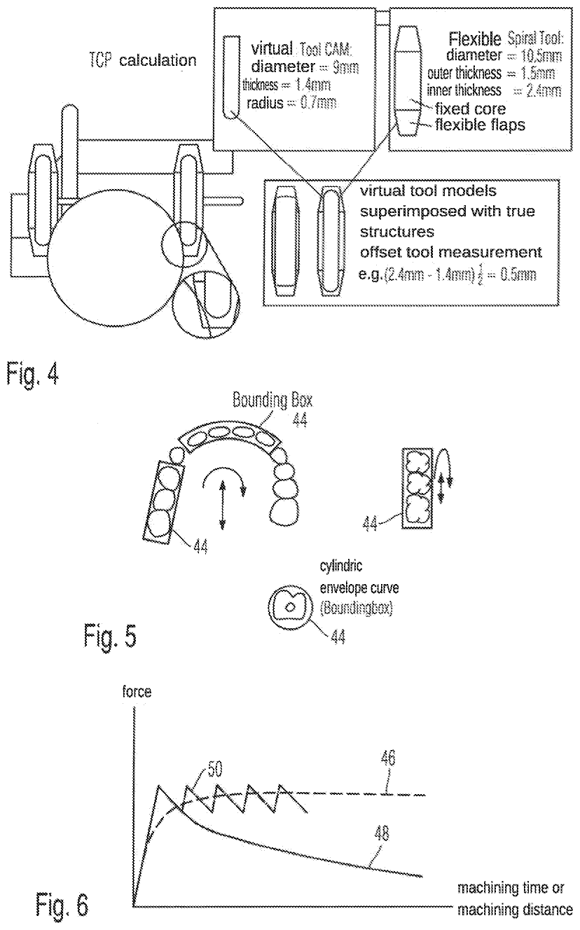

FIG. 4 shows a calculation of the reference point 34 of the tool, which is referred to here as TCP=Tool centre point. A virtual tool is provided for the CAM software, with a diameter of 9 mm and the other specified dimensions.

The polishing assembly 14 is described there as a flexible spiral tool. It consists of the fixed polishing core 16 and the flaps 20. The flaps 20 taper outwards so that their thickness is less on the outside than on the inside.

Below in FIG. 4 an overlay of the virtual tool with the actual tool is shown. The dimensions given there result in an offset of approx. 0.5 mm.

The dimensions given are only exemplary and can be adapted to the requirements in a wide range.

FIG. 5 shows an alternative embodiment with a so-called bounding box 44. A bounding box is a virtual geometry or “box” within which the object to be machined lies.

The bounding box 44 can be generated either by means of the sensor system with distance measurement of tool and dental object or by means of the CAM software.

A bounding box 44 is used, for example, to create a box-shaped or cuboid enclosure of the indication to be polished, as shown in FIG. 5. This eliminates the need to traverse the 3D contour data of the dental indication.

The trajectory 22 can also be created virtually, e.g., in the bounding box 44.

It is conceivable that the bounding box is automatically calculated in the CAM, or that the polishing tool is moved at a predetermined distance from the indications to be polished by means of a sensor system in the milling machine.

A protective geometry can consist of a virtual volume body that fills the cavity and thus smooths the edges of the preparation borders. The cavity is filled with a solid to the level of the degree of immersion above the preparation margin.

The bounding box can be defined completely independently of 3D data. For example, block-specific trajectories “bounding boxes” or indication-specific programmes: “inlay”, crown, bridge, partial dentures, denture base, etc. can be realised. Or, for example, a cylinder bounding box is placed around 3D data (STL data) in preparation for finishing. Polishing is then carried out with a constant radius, but the contours are not traced.

The bounding box is placed at a minimum distance around the contours and then stretched outwards to a maximum degree of immersion at the highest point. FIG. 6 shows a diagram representing the pressing force plotted against time or machining distance.

The dashed curve 46 shows the ideal curve: there is a constant force over the entire polishing time.

The solid curve 48 shows the real course: After dipping, the force drops.

An approximation to the ideal course is possible by regularly or continuously adjusting the degree of immersion, according to curve 50.

An adaptive method for operating a dental polishing device comprising a polishing unit driven by a dental machine tool is provided, said polishing unit consisting of a circular polishing core and a circular polishing assembly surrounding in particular the polishing core, wherein the polishing device also comprises a workpiece to be polished, and wherein the polishing assembly deforms elastically when in contact with the workpiece.

A numerically controlled steering device moves the polishing assembly along a trajectory on and relative to the workpiece.

The workpiece immerses into the polishing assembly by a constant or substantially constant degree of immersion and the control device adjusts the degree of immersion based on process parameters.

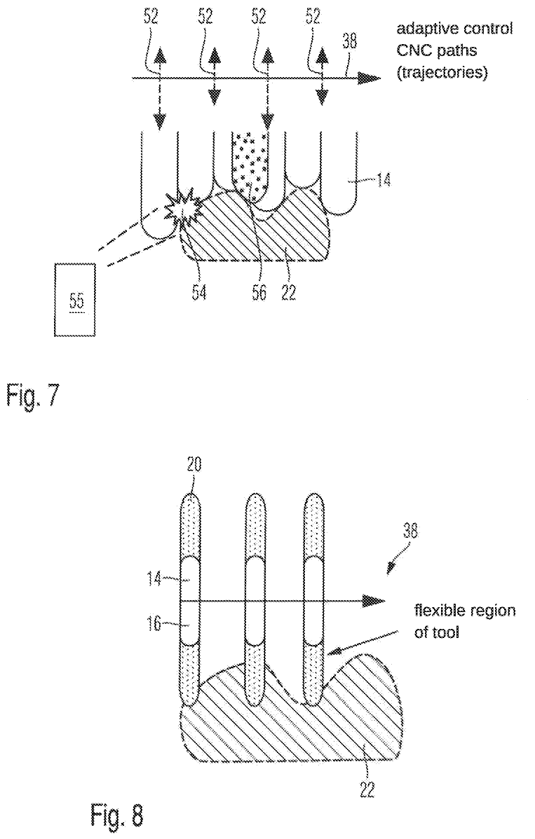

The control of the trajectory 38 is shown in FIG. 7. The actual trajectory of the reference point 34 does not run horizontally, but with vertical deflection, according to the arrows 52. A trajectory calculation is dispensed with, but a stored trajectory is followed. The trajectory can be in a two-dimensional grid. A three-dimensional trajectory, e.g., in cylinder form, is also possible.

As soon as a contact 54 occurs during the horizontal movement, a noise is generated. This noise is detected by an acoustic sensor 55. Polishing begins and the trajectory, and thus the degree of immersion, is continuously adjusted.

As soon as the surface of the workpiece jumps back, as shown at or just before position 56 of the polishing assembly 14, the contact is lost or weakens. This change in noise is detected by the sensor 55, and the trajectory 38 is readjusted via the control device.

FIG. 8 shows an embodiment without adaptive path control. The flaps 20 of the polishing assembly 14 are flexible and follow the contour of the workpiece 22. This requires a sufficiently flexible tool, and a predefined polishing pattern is run.

Any process parameter correlated with tool wear is selected. For this purpose, the empirically determined wear behaviour or the wear behaviour determined in individual test series is accessed. As soon as tool wear is detected on the basis of this, the trajectory towards the workpiece 22 is readjusted, i.e., the polishing assembly 14 is lowered downwards in the illustration according to FIG. 8.

In some embodiments, the innovations may be implemented in diverse general-purpose or special-purpose computing systems. For example, the computing environment can be any of a variety of computing devices (e.g., desktop computer, laptop computer, server computer, tablet computer, gaming system, mobile device, programmable automation controller, etc.) that can be incorporated into a computing system comprising one or more computing devices.

In some embodiments, the computing environment includes one or more processing units and memory. The processing unit(s) execute computer-executable instructions. A processing unit can be a central processing unit (CPU), a processor in an application-specific integrated circuit (ASIC), or any other type of processor. In a multi-processing system, multiple processing units execute computer-executable instructions to increase processing power. A tangible memory may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage, one or more input devices, one or more output devices, and one or more communication connections. An interconnection mechanism such as a bus, controller, or network, interconnects the components of the computing environment. Typically, operating system software provides an operating environment for other software executing in the computing environment, and coordinates activities of the components of the computing environment.

The tangible storage may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage stores instructions for the software implementing one or more innovations described herein.

Where used herein, the term “non-transitory” is a limitation on the computer-readable storage medium itself—that is, it is tangible and not a signal—as opposed to a limitation on the persistence of data storage. A non-transitory computer-readable storage medium does not necessarily store information permanently. Random access memory (which may be volatile, non-volatile, dynamic, static, etc.), read-only memory, flash memory, memory caches, or any other tangible, computer-readable storage medium, whether synchronous or asynchronous, embodies it.

The input device(s) may be, for example: a touch input device, such as a keyboard, mouse, pen, or trackball; a voice input device; a scanning device; any of various sensors; another device that provides input to the computing environment; or combinations thereof. The output device may be a display, printer, speaker, CD-writer, or another device that provides output from the computing environment.

The terms “about” and “substantially” are intended to include the degree of error or uncertainty associated with measurement of the particular quantity or shape as one of ordinary skill in the art would understand.

The scope of protection of the present invention is given by the claims and is not limited by the features explained in the description or shown to the figures.

1. A method for operating a dental polishing device comprising a polishing unit which is driven by a dental machine tool, where the polishing unit comprises a circular polishing core and a circular polishing assembly, which circular polishing assembly surrounds the polishing core, the polishing device also comprising a workpiece to be polished, and the polishing assembly being elastically deformed when applied against the workpiece, the method comprising the following steps:
a numerically controlled controller (40) moves the polishing assembly (14) along a trajectory (38) on the workpiece (22) relative to the workpiece (22), in which the workpiece (22) is immersed into the polishing assembly (14) with a constant or substantially constant degree of immersion (26) and the controller (40) adjusts the degree of immersion (26) based on process parameters.

2. The method for operating the dental polishing device according to claim 1,
wherein the process parameters comprise wear behaviour of the polishing assembly (14) determined empirically or in an individual series of tests, and
wherein the process parameters are dependent on an advance, the material of the workpiece (22), the shape of the workpiece (22), the material of the polishing assembly (14), the shape of the polishing assembly (14) and/or the contact pressure between the polishing assembly (14) and the workpiece (22).

3. A method for operating a dental polishing device comprising a polishing unit which is driven by a dental machine tool, where the polishing unit comprises a circular polishing core and a circular polishing arrangement which circular polishing arrangement surrounds the polishing core, the polishing device also comprising a workpiece to be polished, and the polishing arrangement being elastically deformed when it is applied against the workpiece, the method comprising the following steps:
a numerically controlled controller (40) moves the polishing assembly (14) along a trajectory (38) on the workpiece (22) relative to the workpiece, in which trajectory the workpiece (22) is immersed into the polishing assembly (14) with a constant or substantially constant degree of immersion (26), and
wherein at least one dimension of the polishing assembly (14) and/or the dimensions of the workpiece (22) is measured continuously or repeatedly by a camera sensor, an optical sensor, a mechanical sensor or an acoustic sensor, and
wherein the controller (40) adjusts the degree of immersion (26) based on a measurement result.

4. The method for operating the dental polishing device according to claim 3,
wherein the measurement is carried out as a real-time measurement, and
wherein the controller (40) carries out a regulation of the trajectory (38), via a polishing force determined by the sensor or derived from an output signal of the sensor, and/or
wherein the regulation carries out the rotational speed of the dental machine tool (34) and/or adjusts the polishing force.

5. The method for operating the dental polishing device according to claim 1,
wherein at least one dimension of the workpiece (22) is measured via a sensor prior to execution of the trajectory (38), and
wherein the controller (40) determines the trajectory (38) of the polishing unit (12) prior to the execution.

6. The method of operating a dental polishing device according to claim 1,
wherein a predetermined degree of immersion (26) is greater than 0.05 mm and less than 0.5 mm for immersion devices with a diameter of up to 3 mm, and greater than 0.2 mm and less than 2 mm for tools with a diameter of more than 3 mm.

7. The method for operating the dental polishing device according to claim 1,
wherein the numerically controlled controller (40) has a memory in which a virtual trajectory (38) is stored which corresponds to a contour of the workpiece (22), but reduced by a predetermined degree of immersion (26), that is, closer to the workpiece (22) than corresponds to the actual diameter of the polishing assembly (14), if necessary taking into account a tool reference point (34).

8. The method for operating the dental polishing device according to claim 1,
wherein, with a dental restoration part (20) as the workpiece (22), the controller (40) excludes preparation boundaries of the dental restoration part (20) from the polishing such that a negative degree of immersion (26) is specified at the preparation boundaries, or a virtual protective geometry is inserted over excluded surfaces.

9. The method for operating the dental polishing device according to claim 1,
wherein a targeted degree of immersion is determined in advance, based on at least one series of measurements which represents a function of the degree of immersion (26) via a polishing force, measured via a respective current consumption or rotational speed of the rotary drive of the machine tool (34).

10. The method for operating the dental polishing device according to claim 1,
wherein the controller (40) determines wear of the polishing assembly (14) from a drop in the polishing force at a predetermined degree of immersion (26) and emits a signal when the polishing force at the predetermined degree of immersion (26) falls below a threshold value at the predetermined degree of immersion (26), and
wherein the signal readjusts the compensation movement and/or indicates a tool change.

11. The method for operating the dental polishing device according to claim 1,
wherein the controller (40) controls the relative movement between the workpiece (22) and the polishing assembly (14) along the trajectory (38) such that a speed of movement, during contact, is greater than a minimum value of 5 mm/sec or 10 mm/sec, and less than a maximum value of 30 mm/sec or 20 mm/sec.

12. The method for operating the dental polishing device according to claim 1,
wherein the polishing assembly (14) is brought into contact with the workpiece (22) exclusively in regions outside the axis and/or a tip of the polishing assembly (14).

13. The method for operating the dental polishing device according to claim 1,
wherein the polishing assembly (14) comprises bristles or flaps (20) extending in a circular, plate-shaped, cup-shaped, or cone-shaped manner around the polishing core (16).

14. The method for operating the dental polishing device according to claim 1,
wherein the polishing assembly (14) has a diameter (32) which increases with a rotational speed, and the degree of immersion (26) is determined in relation to the increased diameter (32) such that the rotational speed is adapted to the desired degree of immersion (26).

15. A dental polishing device comprising
a polishing unit which is in driving connection with a dental machine tool, where the polishing unit comprises a circular polishing core and a circular polishing assembly surrounding the polishing core,
a workpiece to be polished, and
wherein the polishing assembly is elastically deformed when in contact with the workpiece,
wherein a numerically controlled controller (40) is provided, which controls the movement of the polishing assembly (14) along a trajectory (38) on the workpiece (22) relative to the workpiece, and
wherein the controller (40) has a degree of immersion control unit, by which the degree of immersion (26) can be adjusted.

16. The dental polishing device according to claim 15,
wherein a constant or substantially constant degree of immersion (26) with which the workpiece (22) is immersed in the polishing assembly (14) can be set with the degree of immersion control unit, and
wherein the immersion degree (26) can be readjusted with the immersion degree control unit based on process parameters or based on a sensor or a camera for recording at least one dimension of the polishing assembly (14) and/or dimensions of the workpiece (22), and/or
wherein the immersion degree (26) can be readjusted with the immersion degree control unit, based on a measurement result.

17. A dental machine tool comprising
a retrofitted dental polishing device which comprises a controller implemented by CAM software or retrofitted by an update of the CAM software, with which a degree of immersion can be readjusted based on process parameters or based on a measurement result of a sensor.

18. A computer program product for a dental machine tool comprising program code with is stored on a non-transitory machine-readable medium, the machine readable medium comprising computer instructions executable by a processor, which computer instructions cause a controller of a dental polishing device integral or retrofitted on the dental machine tool to perform the method according to claim 1.
